(19) United States
(12) Patent Application Publication
(10) Pub. No.: US 2004/0265201 A1
(43) Pub. Date: Dec. 30, 2004

(54) NOx removal system

(76) Inventors: Norman Dale Brinkman, Troy, MI (US); David R. Monroe, Bloomfield Hills, MI (US); David L. Hilden, Shelby Township, MI (US); Patrick G. Szymkowicz, Shelby Township, MI (US)

Correspondence Address: Killworth, Gottman, Hagan & Schaeff, L.L.P., Suite 500, One Dayton Centre, Dayton, OH, 45402-2023, US

(21) Appl. No.: 10/606,193

(22) Filed: Jun. 25, 2003

(51) Int. Cl. B01D 53/56

(52) U.S. Cl. 423/239.1; 422/171; 422/177; 422/172

(57) ABSTRACT

In accordance with one embodiment of the present invention, a NO_{X} removal system is provided for removing nitrogen oxides from a nitrogen oxide containing exhaust. The NO_{X} removal system comprises a NO_{X} treatment section, a diverter, and a hydrogen generation section. The NO_{X} treatment section is configured to remove nitrogen oxides from the exhaust. The diverter is configured to extract water from the exhaust and deliver extracted water to the hydrogen generation section. The hydrogen generation section is configured to deliver hydrogen to the NO_{X} treatment section. The NO_{X} removal system is configured such that the delivery of the hydrogen to the NO_{X} treatment section is substantially isolated from delivery of the exhaust to the NO_{X} treatment section. In accordance with 37 CFR 1.72(b), the purpose of this abstract is to enable the United States Patent and Trademark Office and the public generally to determine quickly from a cursory inspection the nature and gist of the technical disclosure. The abstract will not be used for interpreting the scope of the claims.

### CROSS-REFERENCE TO RELATED APPLICATIONS

The present application is related to co-pending U.S. patent application Ser. No. ______, (attorney docket no. GMC 0040 PA), filed concurrently herewith.

### BACKGROUND OF THE INVENTION

The present invention relates to the generation of process gases and to the use of those process gases in specialized applications. More specifically, the present invention relates to various schemes for the generation of hydrogen, oxygen, or both and to a variety of applications employing the hydrogen, oxygen, or both.

### BRIEF SUMMARY OF THE INVENTION

In accordance with one embodiment of the present invention, a NO_{X} removal system is provided for removing nitrogen oxides from a nitrogen oxide containing exhaust. The NO_{X} removal system comprises a NO_{X} treatment section, a diverter, and a hydrogen generation section. The NO_{X} treatment section is configured to remove nitrogen oxides from the exhaust. The diverter is configured to enable delivery of water to the hydrogen generation section. The hydrogen generation section is configured to deliver hydrogen to the NO_{X} treatment section. The NO_{X} removal system is configured such that the delivery of the hydrogen to the NO_{X} treatment section is substantially isolated from delivery of oxygen, which may exist in the exhaust, for example, to the NO_{X} treatment section.

In accordance with another embodiment of the present invention, a method of operating a NO_{X} removal system to affect removal of nitrogen oxides from a nitrogen oxide containing exhaust is provided. The NO_{X} removal system comprises a NO_{X} treatment section, a diverter, and a hydrogen generation section. The nitrogen oxide containing exhaust is directed through the NO_{X} treatment section to affect removal of nitrogen oxides from the exhaust. Water is delivered to the hydrogen generation section utilizing the diverter. Delivery of the exhaust and the generated hydrogen are controlled such that delivery of the hydrogen to the NO_{X} treatment section is substantially isolated from delivery of a substantial amount of oxygen, which may exist in the exhaust, for example, to the NO_{X} treatment section.

Additional embodiments of the present invention may be gleaned from the following detailed description of the invention. Accordingly, it is an object of the present invention to provide for improved schemes for the generation of process gases and to the use of those process gases in specialized applications. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a schematic illustration of a NO_{X} removal system according to one embodiment of the present invention;

FIG. 2 is a schematic representation of a vehicle incorporating a NO_{X} removal system according to one embodiment of the present invention;

FIG. 3 is a schematic illustration of a hydrogen/oxygen generation device according to one embodiment of the present invention;

FIG. 4 is a schematic illustration of an electrolysis unit according to one embodiment of the present invention;

FIG. 5 is a schematic illustration of a hydrogen/oxygen generation device integrated with a series of peripheral devices according to one embodiment of the present invention; and

FIGS. 6A and 6B illustrate the construction of a heat exchanger according to one embodiment of the present invention.

### DETAILED DESCRIPTION

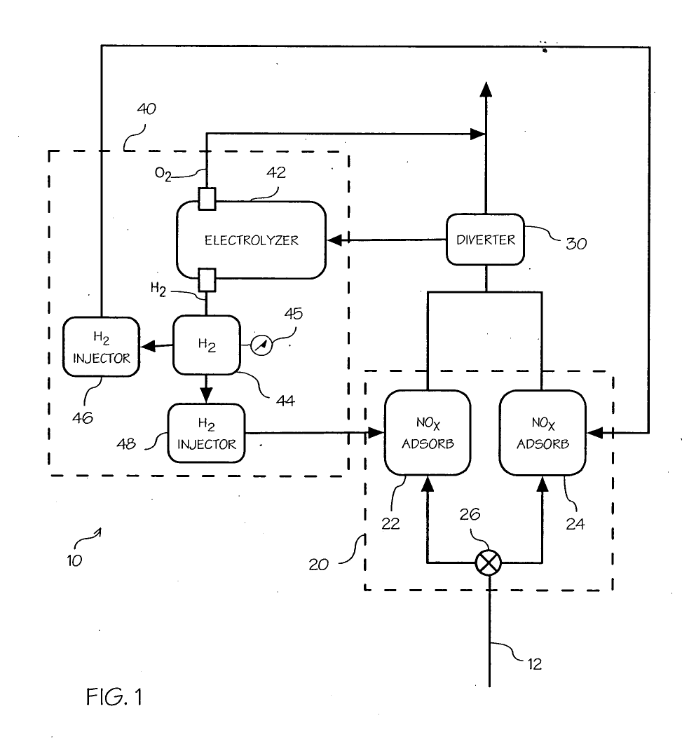

Referring initially to FIG. 1, a NO_{X} removal system 10 according to one embodiment of the present invention is illustrated. The NO_{X} removal system 10 removes nitrogen oxides from a nitrogen oxide containing exhaust 12. The NO_{X} removal system 10 comprises a NO_{X} treatment section 20, a diverter 30, and a hydrogen generation section 40.

The NO_{X} treatment section 20 is configured to remove nitrogen oxides from the exhaust 12. Of course, as will be appreciated by those practicing the present invention and familiar with NO_{X} treatment of exhaust, reference to the removal of nitrogen oxides is not intended to be limited to complete or entire removal of all nitrogen oxides from the exhaust. Rather, the extent to which the NO_{X} treatment section 20 affects removal of the nitrogen oxides from the exhaust depends upon the operating characteristics of the NO_{X} treatment section 20.

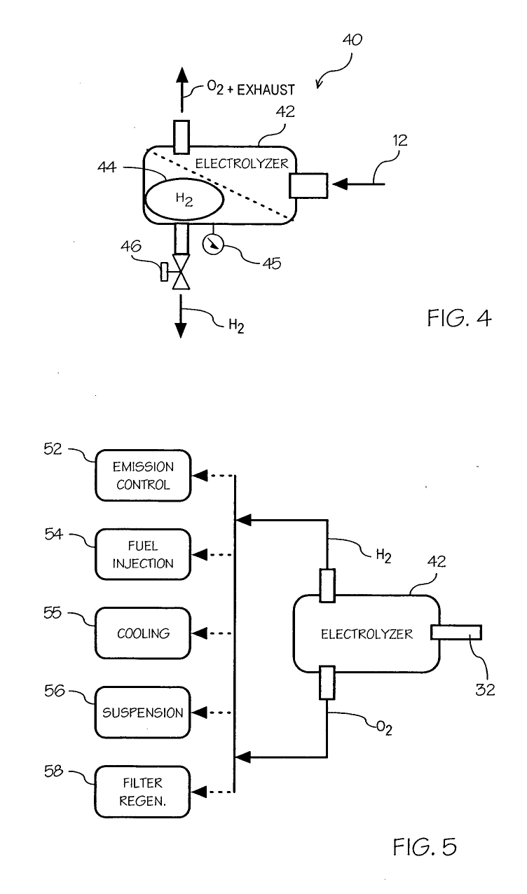

The diverter 30 is configured to enable delivery of water to the hydrogen generation section 40 by, for example, extracting water from the exhaust and delivering the extracted water to the hydrogen generation section 40. Of course, it is contemplated that a variety of suitable diversion schemes may be utilized to enable delivery of water to the hydrogen generation section 40 including, but not limited to, liquid phase selective water diversion, vapor phase selective water diversion, exhaust diversion, etc. In the illustrated embodiment, the diverter, which may comprise a semi-permeable vapor separation membrane unit, a condensation unit, combinations thereof, or any other suitable structure for enabling the delivery of water to the hydrogen generation section 40, is positioned downstream of the NO_{X} treatment section 20 but may be positioned anywhere along the exhaust stream. As is described in further detail with reference to FIGS. 3 and 4, the diverter may merely comprise an exhaust diverter that is not selective of, or preferential to, water or water vapor but nevertheless enables the delivery of water to the hydrogen generation section 40 by directing water-containing exhaust to the hydrogen generation section 40.

The present inventors have recognized that the processes and mechanisms of a variety of NO_{X} treatment schemes may be optimized with intermittent exposure to hydrogen. For example, hydrogen exposure can facilitate both catalyst regeneration and sulfate regeneration in a NO_{X} treatment scheme. Typically, sulfate regeneration requires less frequent but more prolonged exposure to hydrogen than catalyst regeneration. Accordingly, the hydrogen generation section 40 is configured to deliver hydrogen to the NO_{X} treatment section 20 for regeneration of the NO_{X} treatment section 20.

In the illustrated embodiment, the hydrogen generation section comprises an electrolysis unit 42 and a hydrogen storage reservoir 44 fed by a hydrogen output of the electrolysis unit 42. The hydrogen generation section 40 may comprise a pressure monitor 45 configured to monitor the accumulation and storage of hydrogen therein. Hydrogen injectors 46, 48 may also be provided as a means of controlling delivery of hydrogen stored in the reservoir 44. As will be clear from the following description of the present invention, it is contemplated that the hydrogen storage reservoir 44 and even hardware configured to perform the function of the hydrogen injectors 46, 48, may be provided external to or internal of the electrolysis unit 42. Specifically, in FIG. 1 the hydrogen storage reservoir 44 and the hydrogen injectors 46, 48, are illustrated external to the electrolysis unit 42 while in FIG. 4, the hydrogen storage reservoir 44 is illustrated schematically as internal of the electrolysis unit 42.

The NO_{X} removal system 10 is configured such that the delivery of the hydrogen to the NO_{X} treatment section 20 is substantially isolated from the delivery of a substantial amount of oxygen, which may exist in the exhaust 12, for example, to the NO_{X} treatment section 20. In this manner, the adverse effects of reactions of the hydrogen from the hydrogen generation section 40 and oxygen in the exhaust or from another source may be avoided. For the purposes of defining and describing the present invention, it is noted that a “substantial” amount of oxygen may be quantified as an approximation of the amount of oxygen necessary to result in significant adverse effects to treatment operations in the NO_{X} treatment section 20 due to reactions of the oxygen with hydrogen from the hydrogen generation section 40.

According to one embodiment of the present invention, the NO_{X} treatment section 20 may define at least two independent NO_{X} treatment zones 22, 24. The NO_{X} treatment zones 22, 24 are illustrated in FIG. 1 as independent NO_{X} adsorbers, which typically utilize multiple catalyst beds to affect removal of the nitrogen oxides from the exhaust 12. However, it is noted that any suitable scheme where removal of nitrogen oxides from the exhaust 12 is aided by hydrogenous regeneration may be employed without departing from the scope of the present invention. In the context of NO_{X} adsorbers, the independent NO_{X} treatment zones 22, 24 may be defined by independent NO_{X} adsorbers, by suitably isolated multiple catalyst beds packaged as a single NO_{X} adsorber unit, or by any other suitable means. It is contemplated that other embodiments of the present invention may be configured with only one NO_{X} treatment zone, as opposed to two independent NO_{X} treatment zones. In addition, a plurality of NO_{X} adsorbers may be arranged in series to help address specific performance issues relating to cold start or other conditions.

As is illustrated in FIG. 1, the NO_{X} removal system 10 is configured to deliver the exhaust 12 to one of the independent NO_{X} treatment zones 22, 24 on a selective basis. To this end, the NO_{X} treatment section 20 includes a flow diverter valve 26 or any other suitable arrangement for controlling the delivery of the exhaust 12 to one treatment zone or the other. The NO_{X} removal system 10 is also configured to deliver the hydrogen from the hydrogen generation section 40 to one of the independent NO_{X} treatment zones 22, 24 on a selective basis. To this end, the hydrogen generation section 40 is configured to accumulate and store hydrogen and to deliver hydrogen to one of the independent NO_{X} treatment zones 22, 24 on a selective basis. For example, in the illustrated embodiment, each of the hydrogen injectors 46, 48 is in communication with different independent NO_{X} treatment zones 22, 24 of the NO_{X} treatment section 20. In this manner, the hydrogen and the exhaust may each be delivered to different ones of the independent NO_{X} treatment zones 22, 24 on a selective basis.

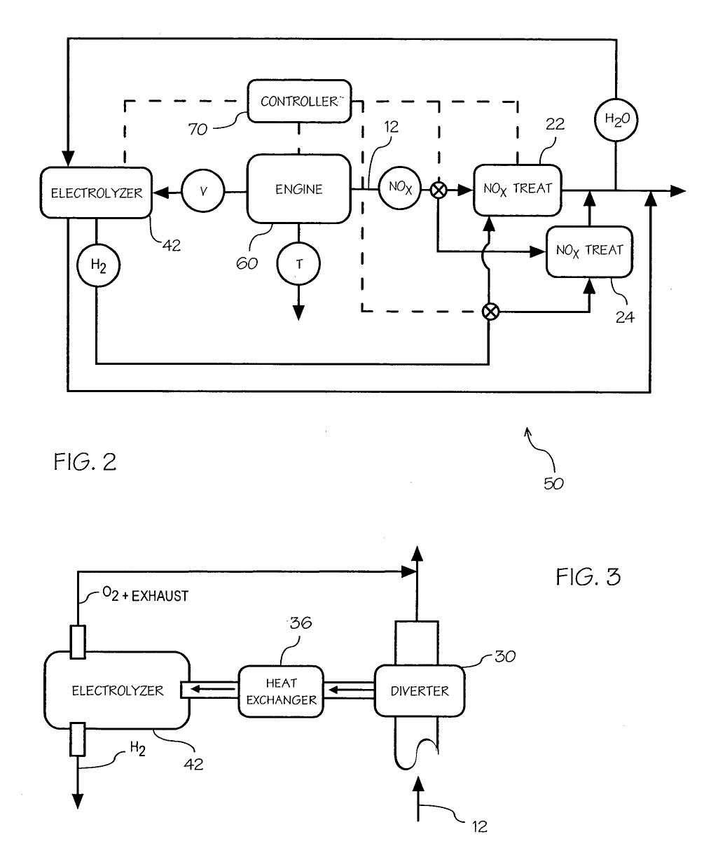

Referring now to FIG. 2, the present invention is illustrated in the context of an integrated device where a device 50, such as a vehicle or a generator or other stationary device, powered by an engine 60 is provided with a NO_{X} removal system according to the present invention. A suitable programmable controller 70 is also provided for integrating the operations and functions of the device 50, engine 60 and the NO_{X} removal system. The engine 60 generates torque T, exhaust containing nitrogen oxides NO_{X}, and, an electric potential V with the aid of an electrical generator or other suitable device. In some applications, the engine will comprise a diesel engine or other type of lean exhaust engine where excess oxygen is present in the exhaust. For example, the oxygen content of the exhaust may be between about 1 and about 20 percent, by weight.

The controller 70 is programmed to control delivery of the exhaust and the hydrogen to the NO_{X} treatment zones 22, 24 to affect regeneration of the treatment zones while ensuring that the delivery of the hydrogen to the respective treatment zones 22, 24 is substantially isolated from the delivery of the exhaust to the respective treatment zones 22, 24. One suitable regeneration scheme utilizes the controller to monitor a condition indicative of NO_{X} removal in the respective treatment zones 22, 24 and divert exhaust from the treatment zone when the treatment zone approaches its nitrogen oxide removal capacity. For example, the controller 70 could be programmed to monitor the cumulative torque output of the engine, the duration for which a selected treatment zone is exposed to exhaust, the NO_{X} level of the exhaust downstream of the treatment zone, etc.

The controller 70 is programmed to cause the hydrogen to be delivered to a selected treatment zone after exhaust is diverted from the treatment zone. In this manner, treatment zones may be automatically regenerated by exposure to hydrogen after they reach an operational threshold that is near the nitrogen oxide removal capacity of the treatment zone. Successfully regenerated treatment zones are subsequently made available for further exposure to exhaust.

The controller 70 may also be programmed to monitor the accumulation and storage of hydrogen in the hydrogen generation section as a means of avoiding the generation of excess hydrogen in the hydrogen generation section 40. To this end, the pressure monitor 45 illustrated in FIG. 1 may be placed in communication with the controller 70.

In a vehicle provided with an automated NO_{X} removal system according to the present invention, a nitrogen oxide containing exhaust is directed through the NO_{X} treatment section 22 to cause nitrogen oxides to be removed from the exhaust 12. Delivery of the exhaust 12 to the NO_{X} treatment section 20 and delivery of hydrogen generated by the hydrogen generation section 40 to the NO_{X} treatment section 20 are controlled such that the delivery of the hydrogen is substantially isolated from the delivery of the exhaust 12.

Specifically, the removal of nitrogen oxides by one treatment zone of the NO_{X} treatment section 20 may be monitored and used to control the diversion of exhaust from the treatment zone when the treatment zone approaches its nitrogen oxide removal capacity. The exhaust may be diverted, for example, to a previously regenerated independent treatment zone. Subsequently, hydrogen is delivered to the treatment zone from which the exhaust was diverted. Delivery of the hydrogen to the treatment zone may be interrupted prior to diversion of the exhaust back to the treatment zone to maintain isolation of the exhaust and the hydrogen. To preserve operational efficiency and reduce burden on the hydrogen generation section 40, the hydrogen may merely be delivered to the selected treatment zone for an amount of time sufficient to regenerate the nitrogen oxide removal capacity of the treatment zone. The diverted exhaust may be diverted back to the initial treatment zone at any time following regeneration of the zone but prior to the time at which the independent treatment zone reaches its nitrogen oxide removal capacity.

Referring now to FIG. 3, the diverter 30 illustrated in FIG. 1 may be configured to divert a portion of the exhaust 12 to a heat exchanger 36 configured to increase the fractional relative humidity of the diverted exhaust 12. The heat exchanger 36, which may, for example, comprise an air-to-air heat exchanger, is configured to increase the fractional relative humidity of the diverted exhaust by at least as much as is required for suitable electrolyzer operation. For example, the heat exchanger may be configured to increase the fractional relative humidity of the diverted exhaust to about 80% or, in other cases, by at least one order of magnitude. The beat exchanger may be provided with, or placed in communication with, additional hardware, such as one or more permeable membranes, for extracting or concentrating water in the diverted exhaust.

It is contemplated that a sufficient supply of water may be generated by configuring the diverter 30 to divert less than about 25% of the exhaust, although the portion to be diverted will vary depending upon the specific operating conditions involved. The diverter may comprise any structure suitable for apportioning and directing respective portions of an exhaust flow. The controller 70, diverter, and any suitable associated hardware may be configured such that exhaust diversion is deactivated where the vehicle body decelerates since there is often little usable water in the exhaust under such conditions.

Referring to FIG. 4, a hydrogen generation section 40 for generating hydrogen and oxygen from a water vapor containing exhaust 12 is illustrated. The hydrogen generation section 40 comprises an electrolysis unit 42 defining a hermetically sealed void volume 44 configured to accumulate and store hydrogen generated by the electrolysis unit 42. Hydrogen is delivered at a hydrogen output of the electrolysis unit 42. It is contemplated that if water, as opposed to merely a water vapor containing exhaust, were delivered to the hydrogen generation section 40, an exhaust of substantially pure oxygen could also be generated by the hydrogen generation section. In which case, oxygen generated in the electrolysis unit 42 may be delivered at an oxygen output of the hydrogen generation section 40 and put to an additional use or may merely be recombined with the exhaust. For example, where the exhaust is generated by an internal combustion engine, the oxygen may be delivered to the engine to enhance combustion, or delivered to one or more of a variety of components of the engine's emission control system to improve emissions control performance. Further examples of the constructive uses for the oxygen output are discussed below with reference to FIG. 5.

As is discussed above with reference to the pressure monitor 45 of FIG. 1, a pressure monitor 45 may also be provided in the embodiment of FIG. 4 to monitor the accumulation and storage of hydrogen within the void volume 44. One or more hydrogen injectors 46 or another suitable valve assembly is also provided and is configured to control release of hydrogen stored within the void volume 44. As is discussed above with reference to FIG. 2, a controller (not shown in FIG. 4) may be provided and configured to monitor accumulation and storage of hydrogen in the void volume 44. The void volume 44 may be defined within and by the body and structure of the electrolysis unit 42.

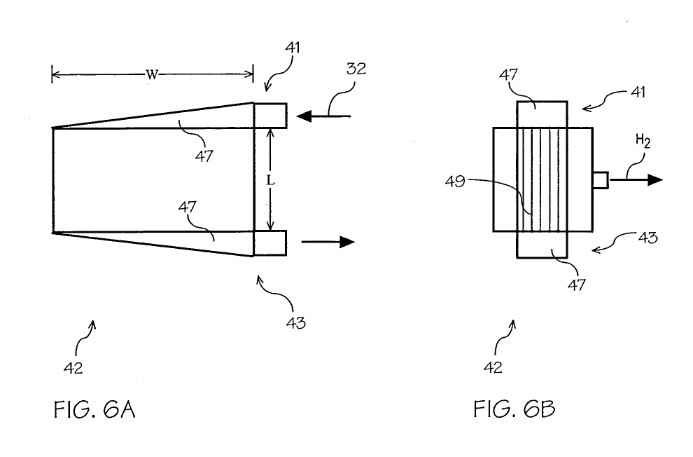

Referring to FIGS. 6A and 6B, the electrolysis unit 42 may comprise hermetically sealed external box type manifolds 47 on the exhaust input and output sides 41, 43 of the electrolysis unit 42. The presence of the box type manifold 47 on the exhaust input sides 41 of the electrolysis unit 42 tends to increase the efficiency of the electrolysis operation.

It may be preferable to ensure that the width dimension W of the electrolysis unit 42 is larger than, or at least twice as large as, the length dimension L of the electrolysis unit 42. In this manner, the hydrogen generation efficiency of the electrolysis operation may be optimized by increasing the area of the free flow region at the frontal area of the flow field grooves 49 within the unit 42. As is illustrated schematically in FIGS. 6A and 6B, the flow field grooves 49 defined by the electrolysis unit extend at least as far as the external box type manifolds 47 on the input and output sides 41, 43 of the unit 42. To optimize flow field uniformity, the external box type manifolds 47 may be tapered from a maximum cross sectional area at an input end of the manifold 47 to a minimum cross sectional area at an terminal end of the manifold 47.

The preferred capacity of the void volume 44 illustrated in FIG. 4 and the hydrogen storage reservoir illustrated in FIG. 1 depends in large part upon the requirements of the particular system in which the hydrogen generation section 40 is utilized. For example, characterizing the specific volumetric capacity in terms of the cell area of the electrolysis unit, it is noted that suitable capacities include, but are not limited to, volumes of about 0.1 mL/cm² at a pressure of about 300 psi (2100 kPa) or about 0.2 mL/cm² at a pressure of about 50 psi (350 kPa). More generally, volumes of between about 0.01 mL/cm² and 10 mL/cm² at pressures of between about 5 psi (35 kPa) and about 1500 psi (10,500 kPa) are also likely to be suitable for many applications. In additional embodiments of the present invention, suitable volumetric and pressure capacities of the hydrogen storage components include about 1 L and at least about 300 psi (2100 kPa), respectively. Alternatively, the volumetric and pressure capacities may be less than about 2 L and at least about 200 psi (1400 kPa). More generally, volumetric and pressure capacities may be between about 50 mL and about 5 L and about 200 psi (1400 kPa) and about 1500 psi (10,500 kPa), respectively.

Regarding the operational characteristics of the electrolysis unit 42, where the exhaust is characterized by a fractional relative humidity of about 1 to about 3 percent, there are advantages to utilizing an electrolysis unit 42 that is configured to generate a substantial amount of hydrogen and oxygen from an input exhaust characterized by a fractional relative humidity of about 1 to about 3 percent. In low humidity applications, it will be advantageous to ensure that the hydrogen generation section 40 comprises an electrolysis unit 42 configured to generate a substantial amount of hydrogen and oxygen from an input exhaust characterized by a fractional relative humidity of about 3% at about 125° C. in still other applications, it will be preferable to thermally couple the electrolysis unit 42 to the exhaust duct of the system, providing a means by which the waste heat of the electrolysis unit can be absorbed in the exhaust gas.

Regarding the hydrogen generation capacity of the electrolysis unit 42, in applications where the unit is utilized in cooperation with a NO_{X} treatment system of an internal combustion engine, it will be sufficient to ensure that the electrolysis unit 42 is arranged to generate in the vicinity of at least about 5 mg/s for smaller engines (about 3L displacement), in the vicinity of at least about 10 mg/s for larger engines (about 6L displacement)—with the understanding that larger generation rates will typically be advantageous.

Referring to FIG. 5, the hydrogen generation section 40 may be configured to deliver hydrogen and/or oxygen, which is generated as a byproduct of hydrogen generation, to one or more peripheral systems in addition to the NO_{X} treatment section 20. Specifically, the peripheral system may comprise an emission control system 52 and oxygen may be delivered to one or more components of the system to improve the performance of those components. The peripheral system may comprise a fuel injection system 54 and hydrogen or oxygen may be delivered thereto to enhance combustion. Additionally, the peripheral system may comprise an engine cooling system 55 or a suspension system 56 for the vehicle. The peripheral system may also comprise a filter regeneration system 58, where a hydrogen or oxygen supply may be used to clean or otherwise regenerate a particulate or other type of filter in the exhaust line or any other gaseous input or output line.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A device comprising a NO_{X} removal system for removing nitrogen oxides from a nitrogen oxide containing exhaust, said NO_{X} removal system comprising a NO_{X} treatment section, a diverter, and a hydrogen generation section, wherein:
said NO_{X} treatment section is configured to remove nitrogen oxides from said exhaust;
said diverter is configured to enable delivery of water to said hydrogen generation section;
said hydrogen generation section is configured to deliver hydrogen to said NO_{X} treatment section; and
said NO_{X} removal system is configured such that said delivery of said hydrogen to said NO_{X} treatment section is substantially isolated from delivery of a substantial amount of oxygen to said NO_{X} treatment section.

2. A device as claimed in claim 1 wherein said exhaust comprises oxygen.

3. A device as claimed in claim 1 wherein said NO_{X} removal system is configured such that said delivery of said hydrogen to said NO_{X} treatment section is substantially isolated from delivery of said exhaust to said NO_{X} treatment section.

4. A device as claimed in claim 1 wherein said NO_{X} treatment section is configured to remove nitrogen oxides from said exhaust through adsorption.

5. A device as claimed in claim 4 wherein said NO_{X} treatment section comprises a plurality of catalyst beds.

6. A device as claimed in claim 1 wherein said NO_{X} treatment section comprises at least one NO_{X} adsorber.

7. A device as claimed in claim 1 wherein said NO_{X} treatment section defines at least two independent NO_{X} treatment zones.

8. A device as claimed in claim 7 wherein said independent NO_{X} treatment zones are defined by independent NO_{X} adsorbers.

9. A device as claimed in claim 7 wherein said independent NO_{X} treatment zones are defined by multiple catalyst beds packaged as a single NO_{X} adsorber unit.

10. A device as claimed in claim 7 wherein said NO_{X} removal system is configured to deliver said exhaust to one of said independent NO_{X} treatment zones on a selective basis.

11. A device as claimed in claim 10 wherein said delivery of said exhaust is affected by a flow diverter valve.

12. A device as claimed in claim 10 wherein said NO_{X} removal system is configured to deliver said hydrogen from said hydrogen generation section to one of said independent NO_{X} treatment zones on a selective basis.

13. A device as claimed in claim 12 wherein said NO_{X} removal system is configured to deliver said hydrogen and said exhaust to said NO_{X} treatment section such that each is delivered to different ones of said independent NO_{X} treatment zones on a selective basis.

14. A device as claimed in claim 1 wherein said diverter is positioned downstream of said NO_{X} treatment section.

15. A device as claimed in claim 1 wherein said diverter is configured to extract water from said exhaust.

16. A device as claimed in claim 1 wherein said diverter comprises a condensation unit or a semi-permeable membrane.

17. A device as claimed in claim 1 wherein said hydrogen generation section is configured to deliver an amount of hydrogen sufficient to affect desulfation of said NO_{X} treatment section.

18. A device as claimed in claim 1 wherein said hydrogen generation section is configured to deliver an amount of hydrogen sufficient to affect catalytic regeneration of said NO_{X} treatment section.

19. A device as claimed in claim 1 wherein said hydrogen generation section is configured to accumulate and store hydrogen.

20. A device as claimed in claim 19 wherein said hydrogen generation section further comprises a pressure monitor configured to monitor said accumulation and storage of hydrogen.

21. A device as claimed in claim 1 wherein said hydrogen generation section comprises an electrolysis unit.

22. A device as claimed in claim 1 wherein said hydrogen generation section comprises a hydrogen storage reservoir fed by a hydrogen output of said electrolysis unit.

23. A device as claimed in claim 1 wherein said hydrogen generation section is configured to deliver hydrogen to one of at least two independent NO_{X} treatment zones of said NO_{X} treatment section on a selective basis.

24. A device as claimed in claim 1 wherein said hydrogen generation section comprises at least one hydrogen injector.

25. A device as claimed in claim 1 wherein:
said hydrogen generation section comprises a pair of hydrogen injectors; and
each of said hydrogen injectors is in communication with different independent NO_{X} treatment zones of said NO_{X} treatment section.

26. A device as claimed in claim 1 wherein:
said device comprises an engine configured to generate torque; and
said engine generates said exhaust.

27. A device as claimed in claim 26 wherein said engine comprises a diesel engine.

28. A device as claimed in claim 26 wherein said engine is configured such that said exhaust is characterized by an oxygen content of about 1 to about 20 percent, by weight.

29. A device as claimed in claim 26 wherein:
said device comprises an electrical generator driven by said engine; and
said hydrogen generation section is powered by said electrical generator.

30. A device as claimed in claim 26 wherein said device comprises at least one exhaust treatment system in addition to said NO_{X} treatment section.

31. A device as claimed in claim 1 wherein said NO_{X} removal system comprises a controller programmed to control delivery of said exhaust to said NO_{X} treatment section.

32. A device as claimed in claim 31 wherein said controller is programmed to:
monitor a condition indicative of removal of said nitrogen oxides by at least one treatment zone of said NO_{X} treatment section; and
divert exhaust from said treatment zone when said treatment zone approaches its nitrogen oxide removal capacity.

33. A device as claimed in claim 32 wherein said controller is programmed to affect delivery of said hydrogen to said treatment zone following diversion of said exhaust from said treatment zone.

34. A device as claimed in claim 1 wherein said NO_{X} removal system further comprises a controller programmed to control delivery of said hydrogen to said NO_{X} treatment section.

35. A device as claimed in claim 34 wherein:
said NO_{X} treatment section defines at least two independent NO_{X} treatment zones; and
said controller is programmed to deliver said exhaust and said hydrogen respectively to different ones of said independent NO_{X} treatment zones.

36. A device as claimed in claim 34 wherein said controller is configured to monitor accumulation and storage of hydrogen in said hydrogen generation section.

37. A device as claimed in claim 36 wherein monitoring of said accumulation and storage of hydrogen is affected through a pressure monitor in communication with said controller.

38. A device as claimed in claim 1 wherein said device comprises:
a vehicle body or stationary device;
an engine configured to generate said exhaust and sufficient torque to accelerate said vehicle body or power said stationary device.

39. A method of operating a NO_{X} removal system to affect removal of nitrogen oxides from a nitrogen oxide containing exhaust, wherein said NO_{X} removal system comprises a NO_{X} treatment section, a diverter, and a hydrogen generation section, and wherein said method comprises:
directing said nitrogen oxide containing exhaust through said NO_{X} treatment section to affect removal of nitrogen oxides from said exhaust;
delivering water from said exhaust to said hydrogen generation section utilizing said diverter;
controlling delivery of said exhaust to said NO_{X} treatment section and hydrogen generated by said hydrogen generation section to said NO_{X} treatment section such that delivery of said hydrogen to said NO_{X} treatment section is substantially isolated from delivery of a substantial amount of oxygen to said NO_{X} treatment section.

40. A method of operating a NO_{X} removal system as claimed in claim 39 wherein said method comprises:
monitoring a condition indicative of removal of said nitrogen oxides by at least one treatment zone of said NO_{X} treatment section; and
diverting exhaust from said treatment zone when said treatment zone approaches its nitrogen oxide removal capacity.

41. A method of operating a NO_{X} removal system as claimed in claim 39 wherein said exhaust is diverted from said treatment zone to an independent treatment zone when said treatment zone approaches its nitrogen oxide removal capacity.

42. A method of operating a NO_{X} removal system as claimed in claim 39 wherein said method comprises delivering said hydrogen to said treatment zone following diversion of said exhaust from said treatment zone.

43. A method of operating a NO_{X} removal system as claimed in claim 42 wherein delivery of said hydrogen to said treatment zone is interrupted prior to diversion of said exhaust back to said treatment zone.

44. A method of operating a NO_{X} removal system as claimed in claim 39 wherein said method comprises:
monitoring a condition indicative of removal of said nitrogen oxides by said NO_{X} treatment section;
diverting exhaust from a selected treatment zone of said NO_{X} treatment section to an independent treatment zone of said NO_{X} treatment section as said selected treatment zone approaches its nitrogen oxide removal capacity; and
delivering said hydrogen to said selected treatment zone following diversion of said exhaust from said treatment zone to said independent treatment zone.

45. A method of operating a NO_{X} removal system as claimed in claim 44 wherein said hydrogen is delivered to said selected treatment zone for an amount of time sufficient to regenerate said nitrogen oxide removal capacity.

46. A method of operating a NO_{X} removal system as claimed in claim 45 wherein said exhaust is redirected to said selected treatment zone following regeneration of said nitrogen oxide removal capacity.

47. A method of operating a NO_{X} removal system as claimed in claim 45 wherein said exhaust is redirected to said selected treatment zone after delivery of hydrogen to said selected treatment zone is interrupted and as said independent treatment zone approaches its nitrogen oxide removal capacity.

48. A device comprising an engine and a NO_{X} removal system for removing nitrogen oxides from an exhaust generated by said engine, said NO_{X} removal system comprising a NO_{X} treatment section, a diverter, and a hydrogen generation section, wherein:
said exhaust comprises oxygen and nitrogen oxides;
said NO_{X} treatment section is configured to remove nitrogen oxides from said exhaust;
said diverter is configured to enable delivery of water to said hydrogen generation section;
said hydrogen generation section is configured to deliver hydrogen to said NO_{X} treatment section; and
said NO_{X} removal system is configured such that said delivery of said hydrogen to said NO_{X} treatment section is substantially isolated from delivery of a substantial amount of said oxygen in said exhaust to said NO_{X} treatment section.
